(19) United States
(12) Patent Application Publication
(10) Pub. No.: US 2011/0093344 A1
(43) Pub. Date: Apr. 21, 2011

(54) TARGETED INTERACTIVE CONTENT FOR IN-STORE RETAIL CUSTOMERS

(76) Inventors: Wells D. Burke, Atlanta, GA (US); Douglas J. Kruep, Dunwoody, GA (US); Jason E. Linscott, Atlanta, GA (US); Robert W. Drew, III, Atlanta, GA (US)

(21) Appl. No.: 12/909,530

(22) Filed: Oct. 21, 2010

Related U.S. Application Data
(60) Provisional application No. 61/253,572, filed on Oct. 21, 2009.
(60) Provisional application No. 61/319,527, filed on Mar. 31, 2010.

(51) Int. Cl. G06Q 30/00

(52) U.S. Cl. 705/14.65

(57) ABSTRACT

Systems and methods are disclosed for operating an interactive content system in a retail environment. As items are scanned at a point of sale system, item data may be provided to an interactive content system and used to generate one or more messages that may presented to a customer offering other items, which may be offered at a discount. Message may be selected based on a relative ranking of available messages. The customer may select one or more of the other items directly on a display, or a cashier may include such items in the transaction at the direction of the customer. Items presented to a customer in a message may be ordered or presented in a format based on item ranking. A cashier may be provided with a script including prompts regarding suggested items.

### CROSS-REFERENCE TO RELATED APPLICATIONS

The subject matter disclosed herein claim priority to U.S. Provisional Patent Application No. 61/253,572, filed Oct. 21, 2009, and U.S. Provisional Patent Application No. 61/319,527, filed Mar. 19, 2010, both entitled “Method and System for Delivering Targeted Interactive Digital Content to In-Store Retail Shoppers”, and both of which are hereby incorporated herein by reference in their entirety.

### TECHNICAL FIELD

The disclosed systems and methods generally relate to providing interactive digital content to customers in a retail setting.

### BACKGROUND

In a modern retail setting, consumer retail transactions that are performed in a physical retail space are typically completed at a Point of Sale (POS) computer terminal that may be one or more computers and peripheral devices designed and/or configured to perform retail transactions. Today's POS terminals are significantly more sophisticated than the typical cash register used in the past. A POS terminal may be configured to identify and price items by scanning product identifying bar codes, weigh items being sold, automatically update inventory systems, connect to credit and debit card payment networks, collect consumer sales information for affinity programs, and perform a wide variety of additional functions. Many POS systems may be programmed with pricing rules that allow retailers run promotions offering consumers various discounts and incentives. While POS systems offer many functions and benefits to the retailers and hopefully speed up the shopping check out time, in the current state of the art, a customer's interaction with a POS system or terminal is generally limited to reporting of sales totals and collecting payments.

While computer technology has rapidly evolved cash registers into POS systems, such technology has not similarly changed the landscape of in-store advertising. Advertisers and marketers still rely heavily on printed signage to advertise their products, prices, and specials. In recent years, thinner and less expensive LCD displays have enabled marketers to augment traditional printed advertising with “digital signs”. However, such digital signs do not provide for interaction with a potential customer and may simply show a single image or rotate through images on a programmed schedule.

The advertising landscape is more complicated for advertisers and marketers now than in the past, and advertising options continue to multiply. The Internet has fragmented and devalued traditional television and print as advertising channels and there is limited physical real estate for display advertising, for example in a physical retail setting. While there are more advertising channels than ever, such channels may each only reach a particular subset or smaller number of consumers than traditional advertising channels have in the past. Advertisers and marketers in today's retail world need systems and methods to provide targeted, timely, and relevant advertising to consumers that are most likely to positively react to such advertising.

### SUMMARY

Systems, devices, and methods are disclosed for operating an interactive content system in a retail environment. In an embodiment, as items are scanned at a point of sale system, item data may be provided to an interactive content system that uses such data to generate or determine one or more potential messages that may be presented to a customers. Such messages may be assigned a rank based on any criteria, and the message selected to be presented to the customer may selected based on the ranking. A group of one or more other items that may be suggested to the customer for purchase may be associated with each message. Each such item may be assigned a rank, and a format of the selected message, such as an ordering of the items associated with the message or the prominence of each such item within the message, may be determined based on the ranking of items associated with the selected message. The message may be presented on one or more displays that may be oriented for viewing by the customer, the cashier, or both. The customer may select items directly on such a display, or a cashier may include such items in the transaction at the direction of the customer. In an embodiment, a message with the suggested items may be presented to the cashier with bar codes associated with such items so that the cashier may directly scan the items from the cashier's display. Different messages may be provided for different displays. A cashier may be provided with a message that includes a script with prompts that the cashier may verbally provide to the customer regarding suggested items.

In an embodiment, an interactive content system may be configured to receive item identification data for an item, determine a plurality of potential messages based on the item identification data, determine a ranking for each of the plurality of potential messages, and determine a highest ranking message from among the plurality of potential messages. The system may be further configured to determine a plurality of message items associated with the highest ranking message, determine a ranking for each of the plurality of message items, and determine a display format of the highest ranking message based on the ranking for each of the plurality of message items. The highest ranking message may be transmitted to a display and the item identification data may be transmitted to a point of sale system. Multiple messages may be transmitted to multiple displays, including a message that has an associated script that may be used by a cashier to verbally prompt a customer with an offer for additional purchases.

In an embodiment, a method of providing interactive content is disclosed. Item identification data may be received at an interactive content system and a plurality of messages based on the item identification data may be determined. A ranking for each of the plurality of messages may be determined, and a highest ranking message from among the plurality of messages may be selected based on the rankings. A plurality of message items associated with the highest ranking message may be determined, as well as a ranking for each of the plurality of message items. A display format of the highest ranking message may be determined based on the ranking for each of the plurality of message items. The highest ranking message may then be presented in the display format on a first display of the interactive content system. The interactive content system may detect a selection of a first message item at the interactive content system and transmit first message item identification data from the system to, for example, a point of sale system. Along with the highest ranking message, a script may provide verbal prompts that may be used by a cashier to encourage the sale of an item displayed or otherwise associated with the highest ranking message. These and additional aspects of the current disclosure are set forth in more detail below.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. In the drawings:

FIG. 1 is a graphical representation of a non-limiting exemplary system in which systems and methods for providing interactive content system may be implemented.

FIG. 2 illustrates a non-limiting exemplary message that may be generated by an interactive content system.

FIG. 3 illustrates another non-limiting exemplary message that may be generated by an interactive content system.

FIG. 4 illustrates another non-limiting exemplary message that may be generated by an interactive content system.

FIG. 5 illustrates a non-limiting exemplary method of implementing an aspect of an interactive content system.

FIG. 6 illustrates another non-limiting exemplary method of implementing an aspect of an interactive content system.

FIG. 7 is a graphical representation of a non-limiting exemplary system for splitting input signals in an interactive content system.

FIG. 8 is a block diagram of a non-limiting, exemplary processor in which the present subject matter may be implemented.

### DETAILED DESCRIPTION OF ILLUSTRATIVE EMBODIMENTS

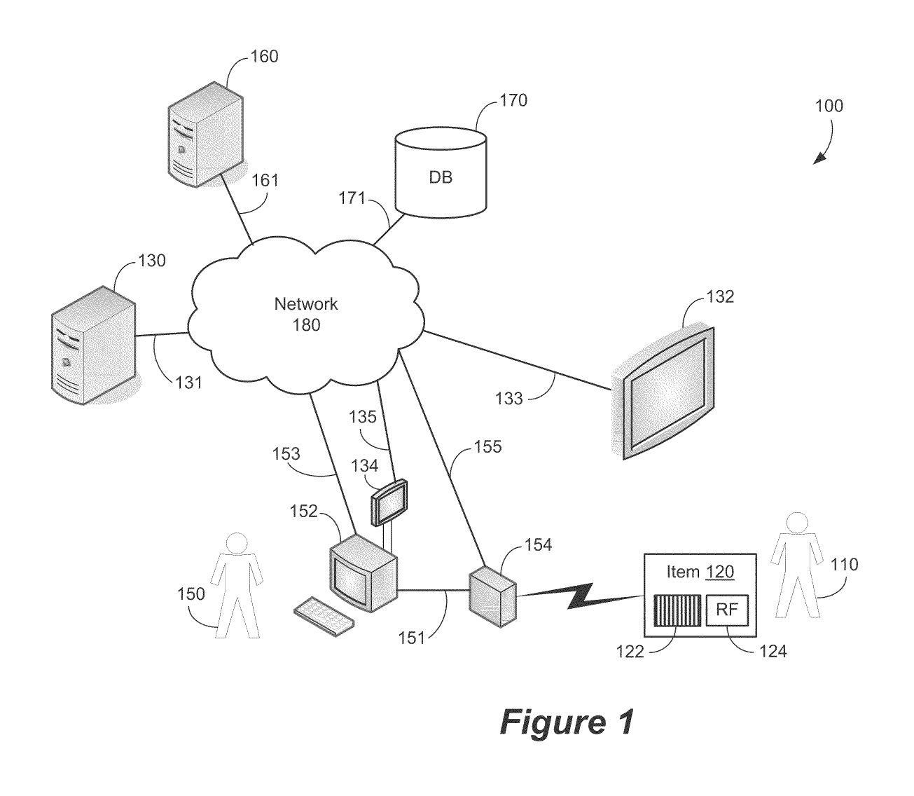

FIG. 1 illustrates a non-limiting exemplary system 100 in which an embodiment of the present disclosure may be implemented. Customer 110 may be purchasing item 120, which may be any good, service, or other purchasable item. The purchase may be taking place in any retail environment or setting. Item 120 may include bar code 122, Radio-frequency identification (RF ID) 124, or any other type of identifier that is capable of being detected by a scanner, sensor, or any other device that may be used to identify items for purchase.

Cashier 150 may be operating a POS system to facilitate the purchase of item 120 by customer 110. The POS system may include POS terminal 152 and scanner 154. Scanner 154 may detect bar code 122 and/or RF ID 124 or any other identifier or identification data associated with item 120. Scanner 154 may process the detected identifier or other identification data and transmit this identifier or data to POS terminal 152. Alternatively, scanner 154 may directly transmit any such detected identifier or other identification data to POS terminal 152. Any type of processing may be performed by scanner 154, and all such processing is contemplated as within the scope of the present disclosure. For example, scanner 154 may determine a time, location, item price, item weight, item category or classification, item quantity, and/or other parameters of the current transaction.

POS terminal 152 and scanner 154 may communicate via communications link 151, which may be any type of wired or wireless communication means, or any combination thereof. Upon receiving the identifier or other identification data (which may include a time, location, and/or other parameters of the current transaction) for item 120, POS terminal 152 may perform typical POS terminal functions, such as determining and adding a price for item 120 to a total amount due, calculating tax, adjusting inventory data to reflect the purchase of item 120, etc. POS terminal 152 may also determine and/or track transaction data and item parameters, such as determine a time, location, item price, item weight, item category or classification, item quantity, codes and/or quantities of other items already scanned, current transaction total cost, customer identification, cashier identification, retail outlet identification, POS terminal location, and/or any other data. POS terminal 152 may determine such data based on information gathered from scanner 154 or from other devices, and scanner 154 and any other device may also determine, maintain, and/or track such data. In performing such functions, POS terminal 152 may communicate with other devices and/or systems via communications link 153, which may be any type of wired or wireless communication means, or any combination thereof.

Communications link 153 may connect to one or more network devices within network 180, which may facilitate communications between two or more devices of any type and function. Network 180 may be any type of data network capable of enabling communications between two or more devices, including the Internet. Network 180 represents any number of interconnected data networks, utilizing any type of communications technologies and protocols, or any combination of technologies and protocols, included wired and wireless communications means.

In an embodiment, interactive content unit 130 may also receive the detected identifier or other identification data, or the results of processing the detected identifier or other identification data by scanner 154. Such data may be transmitted from scanner 154 via communications link 155, which may be any type of wired or wireless communication means, or any combination thereof. Such data may be transmitted to interactive content unit 130 via network 180 and communications link 131, which may be any type of wired or wireless communication means, or a combination thereof. In an alternative embodiment, scanner 154 may be directly connected to interactive content unit 130 using any wired or wireless means, or any combination thereof.

Alternatively, the detected identifier or other identification data, or the results of processing the detected identifier or other identification data by scanner 154, may be transmitted first to POS terminal 152, which may then transmit such data to interactive content unit 130 via communications link 153 and/or network 180. POS terminal 152 may process such data and may determine a time, location, and/or other parameters of the current transaction, and such parameters may be provided with identification data to interactive content unit 130. Alternatively, POS terminal 152 may be directly connected to interactive content unit 130 using any wired or wireless means, or any combination thereof. Interactive content unit 130 may be connected to network 180, or to any other device or network, by communications link 131, which may be any type of wired or wireless communication means, or a combination thereof.

Interactive content unit 130 may also determine and/or track transaction data and item parameters, such as determine a time, location, item price, item weight, item category or classification, item quantity, codes and/or identifiers and/or quantities of other items already scanned in the current transaction, current transaction total cost, customer identification, cashier identification, retail outlet identification, POS terminal location, interactive content unit location, and any other data. Interactive content unit 130 may determine such data based on information gathered from scanner 154, POS terminal 152, and/or from any other device.

Upon receipt of the detected identifier or other identification data, the results of processing the detected identifier or other identification data by scanner 154, or any other data or instruction that causes interactive content unit 130 to acquire, determine, and/or process such data, interactive content unit 130 may process such data by consulting a list of software rules to determine if there is an associated marketing or advertising message that may then be displayed to customer 110 using any of a variety of visual, audio, or other type of communications means. Alternatively, or in addition, interactive content unit 130 may process such data by consulting a list of software rules to determine if there are one or more associated items for which a message may be generated or obtained that may then be displayed to customer 110 using any of a variety of visual, audio, or other type of communications means. Note that such processing may also include analysis of other items previously scanned in the current transaction to determine if there are messages associated with groups of two or more items.

In an embodiment, such software rules may be configured on interactive content unit 130, while in other embodiments, such rules may be remotely located on a database, such as database 170 that may communicate with interactive content unit 130 via communications link 171 and/or network 180. Communications link 171 may be any type of wired or wireless communication means, or a combination thereof. Database 170 may instead be directly communicatively connected to interactive content unit 130 using a wired or wireless communications means, or a combination thereof. Alternatively, database 170 may be physically within the same housing as interactive content unit 130 and/or may be the same device as interactive content unit 130. In an embodiment, such software rules may be imported, downloaded, or otherwise obtained from a POS system, an inventory system, an accounting system, or any other system that may be external to interactive content unit 130. Note that such rules, whether imported or not, may be used to dynamically generate messages. Such systems may be associated with a retail location, a retail operation management entity, a third party, or any other entity. All such configurations are contemplated as within the scope of the present disclosure.

In an embodiment, if no matching software rule is located by interactive content unit 130, interactive content unit 130 may process the received identifier or other identification data and transmit such data (in an embodiment, after processing such data, which may include determining a time, location, and/or other parameters of the current transaction) to one or more other devices for processing and/or evaluation of such data. For example, interactive content unit 130 may transmit such data to server 160, which may be configured to communicate with interactive content unit 130 or other devices directly, or via communications link 161 and/or network 180. Communications link 161 may be any type of wired or wireless communication means, or a combination thereof. Server 160 may determine, based on identification data or parameters associated therewith, an appropriate marketing or advertising message that may be presented to customer 110 via any communications means.

Alternatively, interactive content unit 130 may determine that the identifier or other identification data and/or related parameters meets the requirements of a software rule and may determine an appropriate message to be provided to customer 110 based on the rule. The actual content of such a marketing or advertising message may be determined by interactive content unit 130 by retrieving such content from storage (e.g., memory, disk, etc.) on interactive content unit 130, or by retrieving such content from a remote device such as database 170 or server 160. The marketing or advertising content to be displayed may be combined with additional information or data, such as item identification, item price, tax information, total purchase price, total number of items in the transaction thus far, etc. The function of combining such additional information with marketing or advertising content may be performed by any device, including interactive content unit 130, POS terminal 152, server 160, and/or any other device.

Messages may be selected using various means and methods as described herein. In an embodiment, a group of one or more messages may be determined by interactive content unit 130 to be associated with an item the identifier or other identification data and/or related parameters. Interactive content unit 130 may determine a ranking or priority of such messages based on any criteria, and may select the highest ranked or highest priority message. Interactive content unit 130 may then determine one or more items associated with the selected message. In an embodiment, interactive content unit 130 may also analyze such items to determine a ranking and/or priority for such items based on any criteria, and may determine a presentation order or other format of presentation of the message based on the item ranking. Further embodiments and more details of such methods are presented herein.

Scripts with verbal prompts to be used by a cashier may also be determined by interactive content unit 130 when messages are selected and/or determined. Such scripts may be presented to cashier 150 for use in providing a verbal prompt for additional purchase(s) to customer 110. Further embodiments and more details for methods of determining a script are presented herein.

The message to be displayed or otherwise presented to customer 110 may be communicated to one or more presentation devices, such as display 132 and display 134. Note that while display 132 and display 134 may be described herein with regard to visual display of information and marketing or advertising messages, such displays are also contemplated to include audio, light, and textural presentation means, and such means may be coupled with, or used in place of, visual presentation means. Note also that displays 132 and 134 may be configured or capable of accepting user input, for example via touch sensitive screens or being configured with buttons and/or other sensors. Note also that displays 132 and 134 may be configured to communicate directly with customer devices, for example via WiFi, BlueTooth, or other short range wireless technologies, or other devices may be configured to perform such functions on behalf of an interactive content system. In some embodiments, an interactive content unit may also communicate with customers using text messages, email, Internet services such as Twitter®, All such embodiments are contemplated as within the scope of the present disclosure.

Display 132 may communicate with one ore more devices, such as interactive content unit 130 or server 160, via communications link 133, which may be any type of wired or wireless communication means, or a combination thereof, and/or via network 180. Alternatively, display 132 may be directly connected, via wired, wireless, or a combination of wired and wireless means, to a device such as interactive content unit 130 or server 160. Similarly, display 134 may communicate with one ore more devices, such as interactive content unit 130 or server 160, via communications link 135, which may be any type of wired or wireless communication means, or a combination thereof, and/or via network 180. Alternatively, display 134 may be directly connected, via wired, wireless, or a combination of wired and wireless means, to a device such as interactive content unit 130 or server 160. Alternatively, display 134 may communicate directly with POS terminal 152 which may rely data, information, and/or advertising or marketing messages received from other devices via communications link 153 to display 134. Any combination or permutation of communications means that enable displays such as display 132 and display 134 to receive advertising, marketing, and/or any other content are contemplated as within the scope of the present disclosure.

Note that any of the devices described herein may be integrated into a single housing or implemented as a single unit. For example, either or both of interactive content unit 130 and server 160 may be integrated into a single unit with either display 132 or display 134. For example, interactive content unit 130, server 160, and display 132 may housed or otherwise configured as a single unit “panel” type computer. Any other combination of any of the devices and/or functions described herein may be integrated into a single housing, unit, or device, and all such embodiments are contemplated as within the scope of the present disclosure.

Display 134 may be physically proximate to POS terminal 152. For example, display 134 may be mount or otherwise affixed on or proximate to POS terminal 152, such as on a pole attached to POS terminal 152. Alternatively, display 134 may be mounted or otherwise affixed to a counter upon which POS terminal 152 may be located. Display 132 may instead be located separately from POS terminal 152, for example, mounted on a wall or counter separate from POS terminal 152. Either or both of display 132 and display 134 may be configured or located for ease of viewing by customer 110.

In an embodiment, one of display 132 and display 134, or an additional display, may be located or configured for ease of viewing by cashier 150. Such a configuration may be desired so that cashier 150 may be aware of the marketing or advertising message and other information that is being presented to customer 110. Any script generated or provided for assistance in presenting verbal prompts may also be presented on such a display. This configuration may assist cashier 150 in verbally prompting customer 110 for additional purchases based on the item or group of items detected by scanner 154. Note that display 132 and display 134 may be both configured for viewing by customer 110, and a third display, such as a display configured on POS terminal 152, may present the same information as display 132 and display 134 so that cashier 150 may view such information. Any such configuration or other configuration of display devices, and any number and type of display devices, are contemplated as within the scope of the present disclosure.

Upon receipt of a message, data, images, or any other information to be displayed or otherwise presented to customer 110 by display 132, display 134, and/or any other display device intended for such use, the message, data, images, etc. may be presented on such a device. Note that this may include presentation of visual images and/or video, as well as the presentation of audio information and/or textual information through any means. Note also that different messages and information may be provided to different devices. For example, a message including both advertising content and purchase information (price, tax, etc.) may be presented on display 134 while a larger and more detailed advertising message may be presented on display 132 without purchase or other information. A display of POS terminal 152 may present a message to cashier 150 that include bar codes for scanning and a script for verbal prompts.

In an embodiment, in addition to presenting targeted messages and/or content on one or more display devices, an interactive content system may also, or instead, be configured with input devices that may allow users (e.g., customers and/or cashiers) to select one or more items to be included in the transaction. Such an opportunity for item selection may be presented with a marketing/advertising message or content. The selection of one or more of such items may result in the selected item(s) being integrated into the transaction (i.e., added to the current sale.) For example, a display configured for viewing by the cashier (e.g., a display of POS terminal 152) may incorporate touch screen buttons or other inputs associated with an item that, when touched or otherwise activated, cause the interactive content system to send a Universal Product Code (UPC) of the item to the POS system.

In an embodiment, a display or other input device configured for viewing and/or access by a customer (e.g., display 132 or display 134) may be similarly configured such that the selection of an input associated with one or more items may result in the associated item(s) being integrated into the transaction (i.e., added to the current sale), for example, by display 132 or display 134 transmitting the UPC code of the item(s) to the POS system.

In an embodiment, one or more bar codes, for example as associated with a UPC, of suggested items may be presented on a display (e.g., a display of POS terminal 152) that would allow a cashier to use a scanner to scan the image of the bar code so that the suggested item may be added to the transaction. In such embodiments, a cashier may scan such bar codes using a portable or hand-held scanner (e.g., scanner 154, which may be portable, hand-held, or otherwise include a portable or hand-held scanning device) in response to a customer's verbal acceptance of an offer presented in a marketing or advertising message. In an embodiment, a cashier may also, or instead, verbally prompt a customer in response to a script accompanying, or integrated into, a message presented to the cashier, for example on POS terminal 152. Note that such a message may also be presented to a customer on a display such as display 132 and/or display 134. In other embodiments, an interactive content system and/or a POS system may be configured to print out on paper or another physical medium UPC or bar codes that may be scanned by a scanner to enter items into a transaction. Such physical representations of codes may be kept proximate to a POS system and used by a cashier manually when a customer accepts an offer or otherwise agrees to purchase an item.

In some embodiments, there may be several different items available for selection or item codes available for scanning as part of a marketing or advertising message or content. For example, several items may be offered as options that may be part of a specially priced grouping of items or sale on a group of items. For example, where the scanning of a hot dog and a soft drink is detected, an interactive content system may determine that a message offering the purchase of a bag of chips to create a combination purchase is to be presented (to a cashier, customer, or both.) In another example, in a message that is presented (to a cashier, customer, or both) as the result of an interactive content system detecting the purchase of a single unit of a specific size of soft drink at $1.49, a message may be displayed presenting an offer to purchase two units of the same size of soft drink for $2.22. Additionally, the message may include an offer to purchase a second unit of a different flavor of soft drink for a discounted price. The message may include additional offers, such as an offer to purchase a snack or candy at a discounted price. Any number of offers of any type may be made, an any such offer may be made in conjunction with any embodiment described or contemplated herein.

Several types of messages may be associated with an item or group of items. For example, a device such as interactive content unit 130 or server 160 may determine that an “add-on” message is to be presented to a customer and/or cashier upon detection of the scanning or identification of one or more items. In such an embodiment, one or more items of the same brand, type, flavor, etc., may be offered in such a message. More than one type of message may be associated with an item or a group of items, and more than one of each type of message may be associated with an item or a group of items. As disclosed herein, the best message may be selected using a variety of means. Each message may be associated with more than one item that may be offered to a customer by the message. When presenting multiple offers of items for purchase, for example at a discounted price, in an embodiment, a determination may also be made as to a specific order or way to present such items.

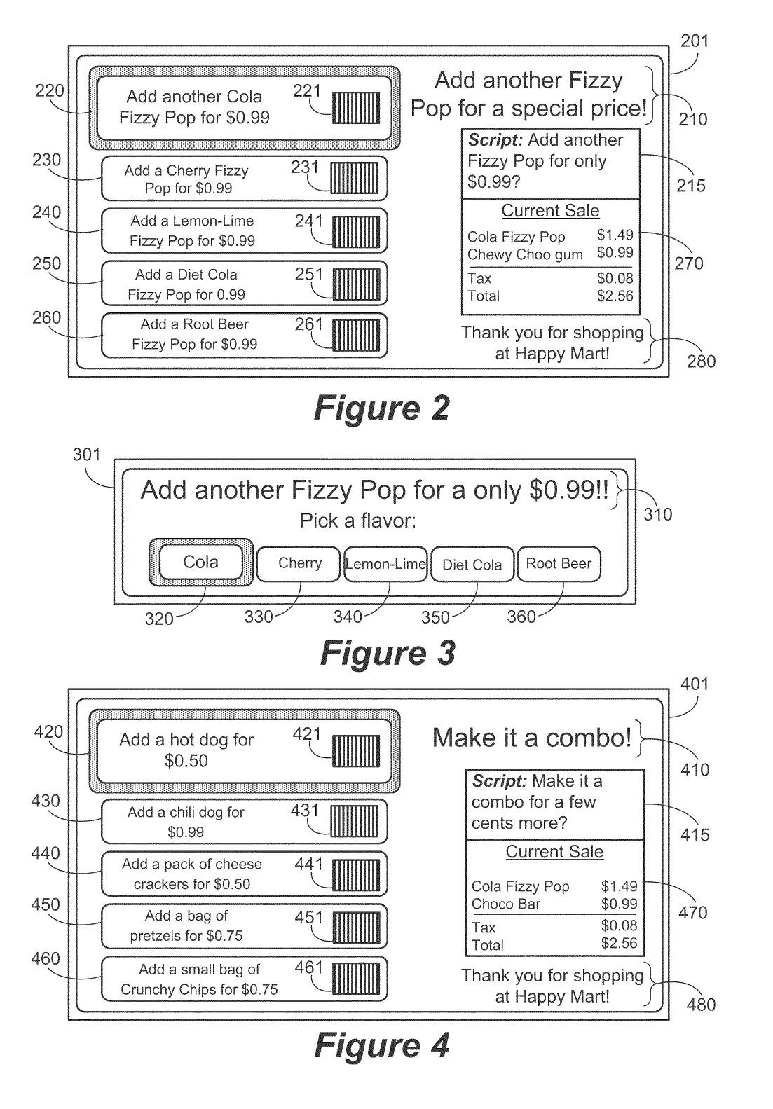

FIG. 2 illustrates a non-limiting example add-on message 201 that may display items for selection in a particular order. Message 201 may be presented to a customer and/or a cashier upon detection by an interactive content system of the scanning of a particular item. Note that message 201 may be presented on any type of display, including any disclosed herein, and may be presented on multiple display viewable by multiple users, including customers and cashiers. In this example, a “Cola Fizzy Pop” scan has been detected, but any item detection is contemplated, as well as any detection of multiple items. Upon determining that a “Cola Fizzy Pop” is part of the current transaction, an interactive content system may determine that one or more messages or promotions are associated with that particular product. Upon determining the messages associated with the scanned product, the interactive content system may then determine the appropriate message for presentation to a customer and/or cashier. Such a determination may be made based on a ranking or priority of such messages, and such a ranking or priority may be determined using any means or method, including those disclosed herein. Upon determining the message to be presented to a customer and/or cashier, the interactive content system may then determine items associated with such a message, and may also determine a rank or priority for such items based on any criteria. The interactive content system may determine how to present the items within the message using such rankings or priorities.

For example, referring again to FIG. 2, message 201 having content regarding other Fizzy Pop products that may be eligible for purchase at a special price may be determined to be associated with the purchase of a “Cola Fizzy Pop”. Upon determining the message and the items associated with the message, the interactive content system may then determine that, from among such items, a second “Cola Fizzy Pop” is the most likely item to be purchased by a customer presented with an offer for any of the group of items. This determination may be made based on any available data, and may be based on ongoing processing of customer and/or transaction data or may be configured by an administrator of such a system. Note that other criteria may be used instead of likelihood of purchase. For example, a retail location may be overstocked on certain items, and may therefore promote such items more aggressively. Any criteria for determining an item to promote over other items may be used, as may be any means or methods of determining such items, and all such embodiments are contemplated as within the scope of the present disclosure.

Upon determining the one or more items from among a group of items associated with a message that are to be offered more prominently or promoted more aggressively, the interactive content system may arrange or display such items within the message accordingly. For example, as seen in FIG. 2, along with offer message 210, which may include an offer or any other information, a listing of options 220, 230, 240, 250, and 260 may be presented. If an interactive content system has determined that an additional “Cola Fizzy Pop” is the most likely item to be purchased by a customer, or otherwise is the item to be promoted or offered more prominently, the additional “Cola Fizzy Pop” may be presented as a larger touch screen button, in a more prominent location, and/or at the top of a list of items, as option 220 is arranged in FIG. 2. Other options representing other flavors of Fizzy Pop may be presented on smaller buttons and lower in a list of items as seen with options 230, 240, 250, and 260 of FIG. 2. Option 220 may be a different color, more brightly illuminated, blinking, include motion or animation, have a different background, etc., in order to set it off against the other items that may be offered.

Any of options 220, 230, 240, 250, and 260 may be selected by a customer, cashier, or other user, and the associated item may be added to the transaction without the actual item being scanned by a scanner. This may facilitate the transaction by allowing the item to be purchased and paid for without the customer or the cashier interrupting the flow of the transaction to physically obtain the item and bring it to a POS system. The customer may then retrieve the additional item on the way out of the store. In an alternative embodiment, selection of any of options 220, 230, 240, 250, and 260 may trigger an order to ship (e.g., mail or via package delivery service) the selected item to the customer. Note that any means allowing a user (e.g., a customer or cashier) to add one or more item(s) to a transaction without actually having to have the item present at a POS system are contemplated by the disclosure.

Note that message 201 may also include bar codes as described above, for example when message 201 is presented to a cashier or when message 201 is presented to a customer that is utilizing the increasingly common self-checkout option that may be presented at some retail outlets. For example, each of options 220, 230, 240, 250, and 260 may have an associated bar code 221, 231, 241, 251, and 261, respectively. Note also that message 201 may include script 215 that may be presented as part of message 201 when message 201 is presented to a cashier. Script 215 may include language that a cashier may use to verbally prompt a customer to purchase an offered item.

Note also that message 201 may include additional information. For example, transaction information 270 may be presented with message 201. Transaction information 270 may include a listing of items already scanned, a running total of the cost of such items, a listing of the tax calculated on the current total cost of such items, and/or a current total cost of the transaction. A date, time, store location, customer identifier, etc. may also be presented in transaction information 270 or anywhere else in message 201. Any other transaction or related information may be included in transaction information 270. Other additional information, such as greeting 280 may be included in message 201.

Different versions of messages may be presented on different displays and intended for different viewer. For example, in a non-limiting exemplary embodiment where message 201 is intended for a cashier (therefore including a script and/or bar codes), message 301 of FIG. 3 may be presented on a display intended for viewing by a customer. Message 301 may be a different version of message 201, containing the same, more, less, and/or different content than message 201. For example, message 301 may include offer message 310 that is abbreviated as compared to offer message 210, or otherwise different than offer message 210 due to the intended viewing of offer message 310 by a customer. Message 301 may have the same or different option as message 201, and such options may have the same or different information presented with them. In an embodiment, message 301 may include options 320, 330, 340, 350, and 360, which may correspond to options 220, 230, 240, 250, and 260 as presented to a cashier in message 201. Note that the more prominently displayed option 320 may correspond to the more prominently displayed option 220 as seen in FIG. 2. Message 301 may also include graphics, animation, other visual content, audio content, or any other content that may be desired in order to attract a customer's attention and encourage a customer to purchase an offered item.

In an embodiment, a combination message type may be used. For example, a device such as interactive content unit 130 or server 160 may determine that one or more items scanned or otherwise identified may be associated with a message that includes content regarding combinations of items that include the one or more scanned items. The interactive content system may determine that a combination message is to be presented to a customer and/or cashier upon detection of the scanning or identification of the one or more items. In such an embodiment, one or more other items that form a combination purchase with the one or more scanned items may be offered to a customer.

FIG. 4 illustrates a non-limiting example combination message 401 that may display items for selection in a particular order. Message 401 may be presented to a customer and/or a cashier upon detection by an interactive content system of the scanning of a particular item or combination of items. Note that message 401 may be presented on any type of display, including any disclosed herein, and may be presented on multiple display viewable by multiple users, including customers and cashiers. In this example, a “Cola Fizzy Pop” scan and a “Choco Bar” scan have been detected, but any item detection is contemplated, as well as any detection of multiple items. Upon determining that a “Cola Fizzy Pop” and a “Choco Bar” are part of the current transaction, an interactive content system may determine that one or more messages or are associated with that particular combination of products. Upon determining the messages associated with the product combination, the interactive content system may then determine the appropriate message for presentation to a customer and/or cashier. Such a determination may be made based on a ranking or priority of such messages, and such a ranking or priority may be determined using any means or method, including those disclosed herein. Upon determining the message to be presented to a customer and/or cashier, the interactive content system may then determine items associated with such a message, and may also determine a rank or priority for such items based on any criteria. The interactive content system may determine how to present the items within the message using such rankings or priorities.

For example, referring again to FIG. 4, message 401 having content regarding other items that may form a combination purchase when purchased with a “Cola Fizzy Pop” and a “Choco Bar” may be presented to a customer and/or cashier. Upon determining the message and the items associated with the message, the interactive content system may then determine that, from among such items, a hot dog is the most likely item to be purchased by a customer presented with an offer for any of the group of items. This determination may be made based on any available data, and may be based on ongoing processing of customer and/or transaction data or may be configured by an administrator of such a system. Note that other criteria may be used instead of likelihood of purchase. For example, a retail location may be overstocked on certain items, and may therefore promote such items more aggressively. Any criteria for determining an item to promote over other items may be used, as may be any means or methods of determining such items, and all such embodiments are contemplated as within the scope of the present disclosure.

Upon determining the one or more items from among a group of items associated with a message that are to be offered more prominently or promoted more aggressively, the interactive content system may arrange or display such items within the message accordingly. For example, as seen in FIG. 4, along with offer message 410, which may include an offer or any other information, a listing of options 420, 430, 440, 450, and 460 may be presented. If an interactive content system has determined that a hot dog is the most likely item to be purchased by a customer, or otherwise is the item to be promoted or offered more prominently, the hot dog option may be presented as a larger touch screen button, in a more prominent location, and/or at the top of a list of items, as option 420 is arranged in FIG. 4. Other options representing other items that may form part of a combination purchase may be presented on smaller buttons and lower in a list of items as seen with options 430, 440, 450, and 460 of FIG. 4. Option 420 may be a different color, more brightly illuminated, blinking, include motion or animation, have a different background, etc., in order to set it off against the other items that may be offered.

Any of options 420, 430, 440, 450, and 460 may be selected by a customer, cashier, or other user, and the associated item may be added to the transaction without the actual item being scanned by a scanner. This may facilitate the transaction by allowing the item to be purchased and paid for without the customer or the cashier interrupting the flow of the transaction to physically obtain the item and bring it to a POS system. The customer may then retrieve the additional item on the way out of the store. In an alternative embodiment, selection of any of options 420, 430, 440, 450, and 460 may trigger an order to ship the selected item to the customer. Note that any means allowing a user (e.g., a customer or cashier) to add one or more item(s) to a transaction without actually having to have the item present at a POS system are contemplated by the disclosure.

Note that message 401 may also include bar codes as described above in regard to FIG. 2, for example when message 401 is presented to a cashier or when message 401 is presented to a customer that is utilizing the increasingly common self-checkout option that may be presented at some retail outlets. For example, each of options 420, 430, 440, 450, and 460 may have an associated bar code 421, 431, 441, 451, and 461, respectively. Note also that message 401 may include script 415 that may be presented as part of message 401 when message 401 is presented to a cashier. Script 415 may include language that a cashier may use to verbally prompt a customer to purchase an offered item.

Note also that message 401 may include additional information. For example, transaction information 470 may be presented with message 401. Transaction information 470 may include a listing of items already scanned, a running total of the cost of such items, a listing of the tax calculated on the current total cost of such items, and/or a current total cost of the transaction. A date, time, store location, customer identifier, etc. may also be presented in transaction information 470 or anywhere else in message 401. Any other transaction or related information may be included in transaction information 470. Other additional information, such as greeting 280 may be included in message 401.

In an embodiment, where message 401 is intended for a cashier (e.g., includes bar codes and/or a script) a different message may be presented to a customer, similar to that shown in FIG. 3. While various embodiments of messages are described herein, for example, in reference to FIGS. 2, 3, and 4, these embodiments are not intended to be limiting and do not imply a requirement of any particular physical or visual configuration or orientation of messages that may be disclosed according to the present disclosure. Any type of message, and any number of messages, presented in any orientation and configuration, using any images, audio, video, animation, data, or any other content, are contemplated as within the scope of the present disclosure.

In an embodiment, among the several types of messages that may be associated with an item or group of items may be an “affinity” message. An affinity message may have associated with it one or more items that have been determined to be most often purchased with the scanned or detected item or group of items. In such an embodiment, the one or more items that are most often purchased with the detected item or group of items may be offered in such an affinity message. Note that the determination of affinity messages may be based in part on a time frame. For example, an interactive content system may determine the messages that have associated with them items that are most often purchased with a detected during the morning hours, or late at night, etc. An affinity message may be similar in appearance and function to the messages described herein in regard to FIGS. 2, 3, and 4. Alternatively, an affinity message may be constructed in any manner and include any functions and/or options. All such messages are contemplated as within the scope of the present disclosure.

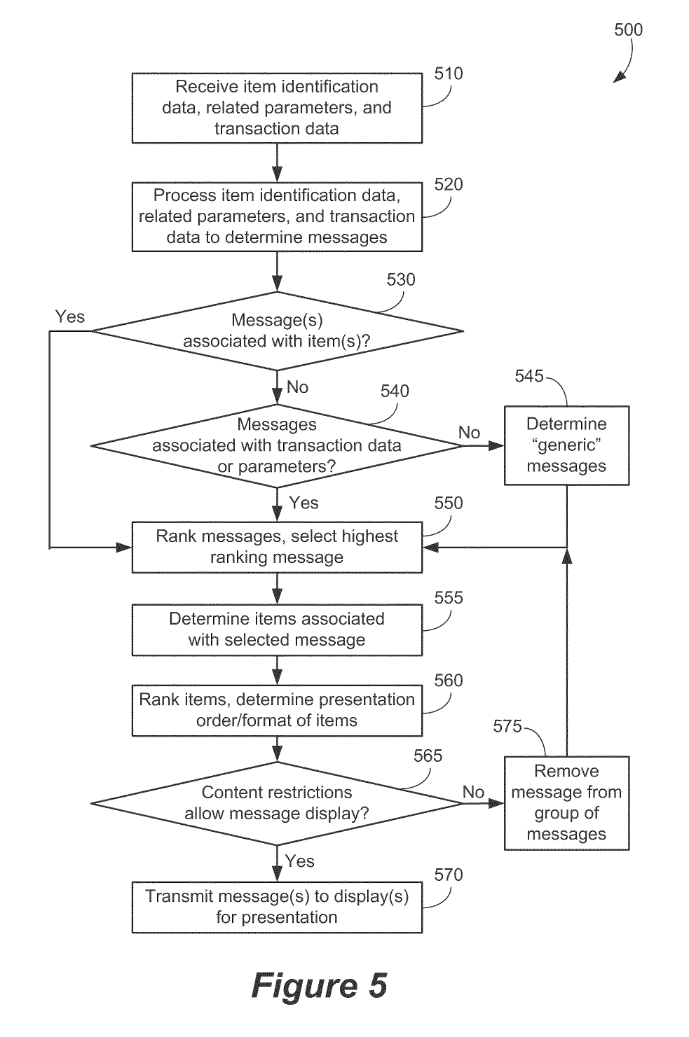

Method 500 of FIG. 5 illustrates a method of determining messages and items to display and the items that should be displayed most prominently. Note that the functions and determinations described in reference to FIG. 5 may be performed in any order and no order or sequence should be implied based on FIG. 5. Note also that any of the functions and determinations described in relation to FIG. 5 may be performed in isolation, in combination with any subset of the functions and determinations described in relation to FIG. 5, and in combination with any other functions or determinations. All such embodiments are contemplated as within the scope of the present disclosure.

At block 510, a scanned item may be detected using any means, including those set forth herein, and identification data may be received by an interactive content system. Transaction data and any related parameters may also be received at block 510. At block 520, an interactive content system may determine whether there are messages associated with the scanned item or with a group of scanned items based on the item identification data and/or one or more groups of items including the scanned item. This determination may also, or instead, take into account other factors, such as transaction data and related parameters, which may include time of day/week/month/year, etc., retail location, inventory levels, customer preferences, sales data over any period of time, etc. Such messages may include content regarding other items that are eligible for promotions, special pricing, etc. when purchased with the detected item, or content regarding other items that a retail outlet operator, administrator of an interactive content system, or any other user wishes to associate with the detected item or group of items. Note that at block 520, the message or group of messages determined to be associated with an item, group of items, or transaction, may be based specifically on the customer. For example, an interactive content system may receive customer identification data (e.g., via a shopper's club card, etc.) and may determine the messages to which the identified customer is most likely to be receptive.

Note that messages and content associated with such messages may be located and/or acquired at any point in method 500 or at any other time. Content associated with messages may include scripts as disclosed herein for assisting a cashier in providing verbal prompts to a customers. Messages and message content may be stored on a remote storage system, in a database, or via some other means, and software rules evaluated, for example at block 520, may simply return an identifier of such content that may then be used, for example by an interactive content unit, to locate, retrieve, or otherwise obtain such content from a storage system, storage device, database, or other device or system. Note that such content may be user or administrator configured and arranged on such a system, or may be preconfigured by an advertising or marketing organization. Note also that messages may be dynamically generated by an interactive content system or another system. In an embodiment, in response to evaluating one or more software rules, one or more messages may be dynamically generated based on any criteria, including a detected item, transaction data, and transaction parameters. In an embodiment, an interactive content system may be configured to utilize both preconfigured messages and dynamically generated messages.

At block 530, a determination may be made as to whether any messages are associated with the recently scanned item or any group of items in the ongoing transaction. For example, an item may be associated with an add-on promotion where multiple such items or similar items (e.g., same brand, same size, etc.) may be purchased at a discount, or an item may be associated with a combination of items that may be purchased at a discount or special price. Alternatively, the type of item may be associated with a message that includes a sale or special offer, such as a special price on dip when a detected item is potato chips, or a sale price on fabric softener when a detected item is laundry detergent. Any association of items and messages may be used, and all such associations are contemplated as within the scope of the present disclosure. Note that such associations may be created and stored using any means or methods disclosed herein, or any other means or methods. Such means and methods include manually administration of an interactive content system and downloading or importing such associations from external sources.

In an embodiment, the analysis performed at block 530 may determine messages based on response rate and item data. For example, upon the detection or identification of a bag of potato chips in a transaction, analysis may be performed, or data may otherwise be obtained, that certain message presented in previous transaction after that particular bag of potato chips has been detected have a higher response rate than others. Note that response rate data may be combined with other data to determine the messages associated with an item at block 530.

If it is determined at block 530 that no messages exist or are otherwise available that are associated with the recently scanned item or any group of items in the ongoing transaction, at block 540, a determination may be made as to whether messages exist or are otherwise available to an interactive content system that are associated with transaction data or other parameters that may be associated with a transaction. Any such parameters or data may be used. Examples of such parameters include time of day/week/month/year, retail location, customer data, and historical sales data over any period of time. For example, a message with a special price on snow shovels may be offered in winter, or a message with a sale price on coffee may be presented in the morning. Any parameter or transaction data may be used to determine messages to be presented to a customer, and all such parameters and criteria are contemplated as within the scope of the present disclosure.

If, at block 540, it has determined that no messages have been identified that are associated with current transaction data or parameters, “generic” messages may be determined at block 545. Note that such messages may be fixed, or may be varied based on any factors, such as time of day, current sales or specials, inventory levels, or any other criteria. The term “generic” as applied to such content is used herein only to differentiate such content from content that is associated with a specific item or group of items, or transaction data or parameters associated with the purchase of an item or group of items, and is not intended to otherwise limit such content.

Upon determining one or more messages that are associated with an item, group of items, transaction data, or parameters, or upon determining one or more generic messages, at block 550 such messages may be ranked or assigned a priority. Such a ranking may be based on any criteria. For example, a distributor or manufacturer may compensate an operator of a retail outlet or an interactive content system for giving messages with content regarding the distributor's or manufacturer's content a higher priority. Alternatively, messages may be ranked by type, for example, add-on messages may be ranked higher than combination messages or affinity messages. In another embodiment, messages may be ranked by response rate, where an interactive content system may track positive responses (i.e., purchases) that result from the presentation of messages and rank messages based on that positive response rate. Any other means or method of ranking messages based on any criteria may be used, and all such embodiments are contemplated as within the scope of the present disclosure. Note that in some embodiments, only a single message may be determined, and therefore ranking may not be performed. Further at block 550, the highest ranking message may be selected. This may be based purely on ranking, or the selected message may be chosen based on any other criteria.

At block 555, one or more items that may be associated with the selected message may be determined. For example, an add-on message may have associated with it several flavors of a brand of soft drink or a combination message may have associated with it several combinations of items. Such associations may be created and stored using any means or methods disclosed herein, or any other means or methods.

Upon determining the items associated with the selected message, at block 560 such items may be ranked or assigned a priority. In an embodiment, items may be ranked according to an analysis of historical sales data over any period of time. In one such embodiment, the items may be ranked in order of frequency of purchase with the scanned item(s) detected at block 510. For example, the item associated with the selected message that is purchased most frequently with the item detected at block 510 may be given the highest priority or ranking, the second most frequently purchased eligible item may be given second highest ranking or priority, etc. In another embodiment, priority or ranking may be determined based on a promotion or by a global item priority. For example, one or more of the items associated with the selected message may be part of a promotion and may be given the highest priority.

In an embodiment, priorities or rankings for items associated with the selected message may be based on inventory levels. For example, items of which there is excess inventory may be ranked higher than items that are at normal or low inventory levels. Alternatively, items associated with the selected message may be ranked based on item profitability. Alternatively, items may be ranked based on item profitability. In another embodiment, rankings or priorities may be assigned based on payment by an item manufacturer or item distributor for priority placement within messages. Any means of implementing “pay for placement” preferences in item ranking and/or promotional selection are contemplated by this disclosure. Additionally, any means of predicting the most likely item choice of the customer and using that prediction to enable faster or more intuitive addition of the selected item to the transaction are also contemplated. Note that any of these ranking criteria may be combined. For example, the time of transaction may be used to determine the item associated with the selected message that sells most frequently with the detected item (from block 510) during a window of time in which the time of transaction falls. Any combination of ranking criteria is contemplated.

Further at block 560, an order or presentation or a layout, configuration, or format of the selected message may be determined based on the ranking. In an embodiment, such configuration may be based purely on ranking, an in other embodiments, the configuration may be determined based on any other criteria in combination with, or in place of, the ranking. For example, the highest ranked item associated with the selected message may placed at the top of a list of items in the message, and the remaining items may be placed in the message in descending order. Alternatively, or in addition, the highest ranking message may be displayed with additional graphics, animation, audio, or other attention-attracting features. Note that only a subset of the items associated with a message may be displayed or otherwise selected for inclusion with the message. For example, a message may have ten items associated with it and may have room to display only five. In such an embodiment, the top five highest ranked items may be selected at block 560 for inclusion in the message.

Note that any of the means described herein for determining messages, determining items to be presented with a message, and the ranking, ordering, or placement of such items within the message may be combined. For example, a first item from a group of items associated with a selected message may be the highest priority due to a promotion, and therefore may be displayed the most prominently. Likewise, the first message associated with a detected item may have the highest priority due to compensation from a distributor of such items associated with the message. The remaining message or items may be ranked lower and may be ordered according to other criteria, such as sales history, current promotions, inventory levels, etc. All such embodiments are contemplated as within the scope of the present disclosure.

At block 565, a determination may be made as to whether content restrictions allow the selected message to be displayed. For example, some messages may not be permitted to be displayed during certain times of day or days of the week, or after certain other items have been scanned, etc. Note that in some embodiments, the activities of block 565 may be performed before doing the analysis of blocks 555 and 560 in order to conserve processing resources. Note also that this function may be combined with the functions of block 520. If there are no restrictions on displaying the selected message, at block 570 the message may be transmitted to one or more displays for presentation to a customer. If there are restrictions on displaying the selected message, at block 575 the selected message may be removed from a group of potential messages as determined, for example, at block 520, and another message may be selected at block 550.

Note that different messages may be determined for different displays based on the detected item or group of items, transaction data or parameters, or destination of the message. For example, for a detected single beverage item, two or more messages may be associated with such an item and each of the two or more messages may be presented on separate displays. A special price on the purchase of two of such beverage items may be presented on a first display, while a special price on the purchase of chips with the beverage item may be presented on a second display. Alternatively, a message including a listing of item bar codes and a script with verbal prompts to assist a cashier in encouraging the sale of items in the message may be displayed on a display configured for cashier use, while a message having only a brief listing of items and enhanced graphics may be displayed on a display configured for customer viewing. Any number and type of messages and message content may be associated with any item or group of items, and all such embodiments are contemplated as within the scope of the present disclosure.

Messages and software rules associated with items and messages may contain any information or data that may be used to associate such content and rules with such items. For example, such rules and/or messages may include, but are not limited to, UPCs or product categories associated with items, a priority of the message that may be used to determine whether such content should be presented in place of other content with a lower priority, a length of time that the content should be displayed, an intended consumer of the content (e.g., cashier or customer), a time of day/week/month/year that the content is eligible/ineligible for display, and one or more previously scanned products that would prevent the content from being selected for display.

More specifically, each message may be assigned parameters that may be used to determine whether and/or how the content should be displayed. For example, an interactive content unit may be configured to display a message for a specific length of time. However, another item may be scanned and a message associated with the item or a group of items including the item may be determined before the termination of the length of time associated with the message that is currently being displayed. If the content currently being displayed has a lower display time parameter (or other characteristic, including a priority or ranking as described herein to determine messages associated with items or item ordering within a message) than the message associated with a more recently scanned item, the message associated with the more recently scanned item may be displayed in place of the content currently being displayed even though the time period associated with the message currently being displayed has not expired. Alternatively, the message currently being displayed may have a higher priority than the message associated with the more recently scanned item. Here, the message associated with the more recently scanned item may not be displayed, or may only be displayed after the time period associated with the message currently being displayed expires.

In an embodiment, messages associated with an item may be configured to not be displayed when other items have been detected. A device or system such as an interactive content unit may be configured to track each item scanned during a transaction, and evaluate each additionally scanned item against the items previously scanned in the transaction.

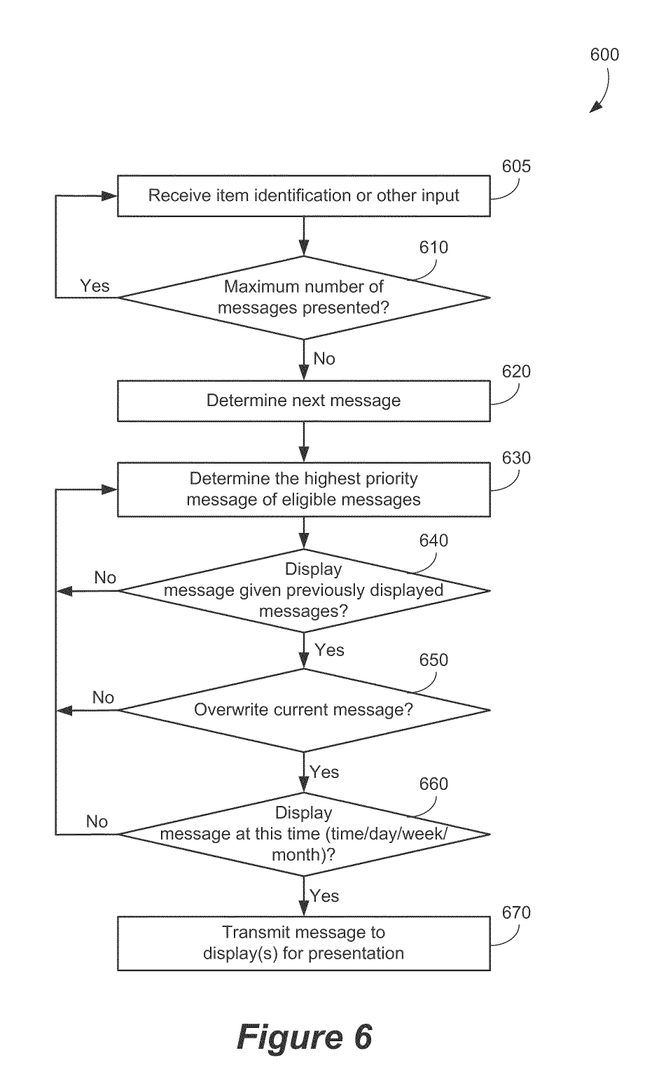

Any other criteria may be used to determine when and whether to display a particular message once that message has been selected. Moreover, in an embodiment, more than one message may be eligible for display at one time, or a message may be selected for display while another message is currently being displayed. Therefore, an interactive content system may be configured determine a message for display from among several available or eligible messages. Method 600 of FIG. 6 illustrates a non-limiting exemplary method of making such a determination. Note that the functions and determinations described in reference to FIG. 6 may be performed in any order and no order or sequence should be implied based on FIG. 6. Note also that any of the functions and determinations described in relation to FIG. 6 may be performed in isolation, in combination with any subset of the functions and determinations described in relation to FIG. 6, and in combination with any other functions or determinations. All such embodiments are contemplated as within the scope of the present disclosure.

At block 605, input may be received at an interactive content system, such as identification data, for example received from a scanner as described herein. Alternatively, such input may be a notification of a new transaction beginning or the termination of a transaction, a resetting of parameters such as the maximum number of allowed messaged or the number messages displayed thus far during the transaction, or any other input. At block 610, a determination may be made as to whether a maximum number of messages that include such content has been presented to a customer. In an embodiment, an interactive content system may be configured to display only a predetermined number of marketing or advertising messages to a customer during a transaction, for example, to prevent the customer from being overwhelmed with marketing or advertising content or to prevent a slowing of sales at a POS system which may result in longer lines for customers. Alternatively, an interactive content system may be configured to display only a predetermined number of marketing or advertising messages to a customer during a specific time period for similar reasons. For example, such a system may be configured to display only five messages containing marketing or advertising content per minute. If the maximum number of messages has been presented, then further input may be received at block 605.

If the maximum number of messages has not been presented to a customer, at block 620, the next eligible content that may be displayed may determined according to any embodiment described herein (for example, as set forth above in regard to FIG. 5) or any other means or method. Note that this determination may result in determining multiple messages or message content that may be presented to a customer. Note that there may also be one or more other messages that may be currently displayed or may be eligible for display at the same time. Therefore, at block 630, a determination of the highest priority message from among the eligible content may be made.

At block 640, a determination may be made as to whether the highest priority message is permitted to be displayed based on messages that have already been displayed. For example, when a customer is buying multiple of the same item, a message associated with the item may have been displayed when the first such item was scanned. Therefore, even though the same message may be selected when a second or third of such an item is scanned, it may be prohibited from display because the interactive content system may have knowledge of a previous display of the message. Such a configuration may prevent redundant message presentation to a customer. If the message cannot be displayed for this reason, the message may be removed from the group of eligible messages, and the highest priority message from the remaining eligible group of messages may be selected at block 630.

If the message may be displayed according to the determination of block 640, at block 650 a determination may be made as to whether the currently highest priority message may be displayed in place of, or overwrite, the currently displayed message. This determination may be made based on message priority, length of time the currently displayed message has been displayed, or any other criteria. If the currently highest priority message may not be displayed in place of the currently displayed message, the currently highest priority message may be removed from the group of eligible messages, and a new highest priority message may be determined at block 630.

If the currently highest priority message may be displayed according to the determination of block 650, at block 660 a determination may be made as to whether the currently highest priority message may be displayed based on the current time. For example, messages may be restricted to display at specific times of day, specific days of the week, month, year, etc. If the currently highest priority message may not be displayed at the present time, the currently highest priority message may be removed from the group of eligible messages, and a new highest priority message may be determined at block 630. If the currently highest priority message may be displayed according to the determination of block 660, at block 670 the message may be transmitted or otherwise provided to one or more displays for presentation to the customer.

Presented now are several non-limiting examples of types of messages that may be generated when example input is detected, and of criteria that may be used to generate such messages. For example, messages associated with an item or a group of items may be of any of the following types, and may be of any other type. The following message types are merely exemplary and are not intended to limit the scope of the present disclosure.

### EXAMPLE 1

Quantity sale or tied sale: Upon the detection (e.g., scanning) of an item, a message may be presented to a customer offering the customer a second of the same item for a reduced price. For example, when a customer purchases one sports drink, another sports drink may be offered at a reduced price or at a specific savings (e.g., “Add a second bottle and save $0.78”).

### EXAMPLE 2

Add on: Upon the detection (e.g., scanning) of an item, a message may be presented to a customer offering the customer a second, different item for a reduced price. For example, when a customer purchases a pack of cigarettes, a fountain drink may be offered at a reduced price or at a specific savings (e.g., “Add a fountain drink for $0.50”).

### EXAMPLE 3

Round out the basket: Upon the detection (e.g., scanning) of an item, a message may be presented to a customer offering to create a package or grouping of related items for purchase. For example, when a customer purchases a breakfast sandwich, a combination deal may be offered (e.g., “Make it a combo for $1.99”).

### EXAMPLE 4

Affinity sale: Upon the detection (e.g., scanning) of an item, a message may be presented to a customer offering the customer a second, different but related item for a reduced price. For example, when a customer purchases a soft drink, a candy bar may be offered at a reduced price or at a specific savings (e.g., “Add a candy bar for $0.49”).

### EXAMPLE 5

New product introduction: Upon the detection (e.g., scanning) of an item, a message may be presented to a customer offering the customer a second, new item. For example, when a customer purchases a soft drink, a new type of candy bar may be offered at a reduced price or at a specific savings (e.g., “Add a new ChocoBar candy bar for $0.29”).

### EXAMPLE 6

Buy one, get one free: Upon the detection (e.g., scanning) of an item, a message may be presented to a customer offering the customer a second of the same item for free. For example, when a customer purchases a DVD, the customer may be notified that they can get a second DVD for free (e.g., “Go pick a second DVD for FREE”).

### EXAMPLE 7

Loyalty program: Upon the detection (e.g., scanning) of an item, a message may be presented to a customer offering a number of points or other benefits for making an additional purchase. For example, when a customer purchases a candy bar, the customer may be notified that they can get double points for buying an additional candy bar (e.g., “Buy second candy bar, get DOUBLE Driver Payback points”).

### EXAMPLE 8

Reminder sale: Upon the detection (e.g., scanning) of an item, a message may be presented to a customer reminding the customer of a second, different but related item in which the customer may be interested. For example, when a customer purchases a Styrofoam cooler, a reminder may be presented regarding purchasing ice (e.g., “Don't forget the ice”).

### EXAMPLE 9

Crazy combination: Upon the detection (e.g., scanning) of two oddly paired items (i.e., items that would rarely be purchased together, or any combination of items that an administrator of an interactive content system may configure), a message may be presented to a customer providing them with notice of a discount (e.g., “That's CRAZY, you deserve 10% off”).

### EXAMPLE 10

Mystery combination: Upon the detection (e.g., scanning) of two specific, predetermined items (i.e., items that an administrator of an interactive content system may configure), a message may be presented to a customer providing them with notice of a discount. For example, upon the scanning of the first item in a combination, a message may be displayed such as “Have you discovered this week's Mystery Combination?”. If the second item is subsequently scanned in the same transaction, a follow-up message indicating the discount may be displayed, such as “Congratulations! You solved the Mystery and get 10% off!”

### EXAMPLE 11

Wheel of Fortune: Upon the detection (e.g., scanning) of an item, which may be any item or a specific item, a “Wheel of Fortune”-type game may be presented that simulates the spinning of a wheel and provides the discount associated with the position of the wheel when the spinning is complete.

### EXAMPLE 12

Slot machine: Upon the detection (e.g., scanning) of an item, which may be any item or a specific item, a slot machine-type game may be presented that allows the customer to activate a button that simulates the spinning of the slot machine cylinders and provides the discount associated with the position of the slot machine cylinders when the spinning is complete.

### EXAMPLE 13

Trivia: Upon the detection (e.g., scanning) of an item, which may be any item or a specific item, trivia facts about that item may be displayed for customer entertainment. For example, upon scanning a candy bar, a message may be displayed such as “Did you know 17 million candy bars are sold worldwide every day?”

### EXAMPLE 14

Statistics: Upon the detection (e.g., scanning) of an item, which may be any item or a specific item, statistics about that item may be displayed for customer entertainment. For example, upon scanning a soft drink, a message may be displayed such as “Did you know this is the 28^{th} soft drink sold here today?”

### EXAMPLE 15

Brand reinforcement: Upon the detection (e.g., scanning) of an item, which may be any item or a specific item, marketing images for the brand of that item may be displayed.

### EXAMPLE 16

External event tie-in: Upon the detection (e.g., scanning) of an item, which may be any item or a specific item, information about related events may be displayed.

In an embodiment, a targeted interactive content system may display various messages, and may change such messages periodically, when it is not displaying messages related to currently active transactions. Such messages may be advertising or marketing messages, news, weather, and/or sports information, entertainment messages (such as clips from movies, TV shows, or music videos) or any other type of content. Such content and messages may also be used as the “generic” content or messages described herein.

The universe of messages from which an interactive content system may select a message may be determined in a number of ways. The messages along with trigger conditions, such as items that must be in the transaction, time of day or week, location, etc., may be provided to an interactive content system via a website or any other computerized input method. Such data may be provided by a user, who may be an operator of the retail outlet, a partner such as the supplier of an item who wants to promote that item and has a price discount agreement with the retail operator, or any other type of user. Messages may be imported automatically from a POS, retailer accounting system, or any other software system that has been configured with item data and/or special promotional pricing rules to be applied to specific item combinations. Alternatively, messages may be dynamically generated based on pricing or software rules. Note that such rules may be imported into an interactive content system from an external system. For example, rules used to configure a POS system to ring up two bottles of a specific soft drink of any flavor may list the single item price, such as one bottle for $1.49, and the price to be applied to a quantity of two (or more in other examples), such as two bottles for $2.49. By inspecting these pricing rules, for example through XML document exchange, database integration, or any other software integration method, an interactive content system may be configured to determine the item codes and quantities that qualify for a discount when paired with particular other item codes and quantities.

Using the soft drink example, an interactive content system may automatically build a promotional message using sales data, transaction data, interactive content system data, any analysis related thereto, and/or image media from a content library based on the item codes. An interactive content system may also, or instead, dynamically generate price information and a sales script. Such information and scripts may be generated based on pricing or software rules, that may be imported into an interactive content system from an external system. Sales scripts may be based on any data disclosed herein, and may be constructed in various ways to encourage a sale. Such scripts may be presented to a cashier to prompt the cashier to present a verbal offer to a customer. For example, a script may include language such as “Would you like to buy two bottles for only $2.22?”, “Would you like to add a second bottle for only $0.73?”, or “Would you like to add a second bottle and save $0.76?” Any script that may be used to verbally offer an item or service to a customer may be generated, and all such embodiments are contemplated as within the scope of the present disclosure.

Note that one message or a set of messages associated with an item may have associated with it more than one script. This may allow for an administrator or user of an interactive content system to select a script that is most suitable to the retail outlet, its customers, or the best judgment of the user or administrator. For example, a store owner may determine that for the store's customers, offering items at a particular savings is most effective. Therefore, the store owner may configure a message that may have script options of “Would you like to buy two bottles for only $2.22?”, “Would you like to add a second bottle for only $0.73?”, and “Would you like to add a second bottle and save $0.76?” to present the script “Would you like to add a second bottle and save $0.76?” to the cashiers of the store. Alternatively, a different user of an interactive content system may determine that offering an additional item at a discounted price is most effective, and may configure such a message to present the script “Would you like to add a second bottle for only $0.73?” to cashiers of that particular retail outlet. In this way, messages may include scripts that essentially convey the same message in different ways, thus allowing a store operator to select the script that is most suitable for the operator's location. Any script options may be used and selected, and all such embodiments are contemplated as within the scope of the present disclosure.

Note that users or operators of an interactive content system may customize such script manually, and may override provided default scripts. In an embodiment, all or a subset of messages utilized by an interactive content system may have multiple scripts associated with them that may be generated automatically based on message and/or item data. For example, messages in an interactive content system may be configured with three script options: a first option to provide offer information in terms of money saved (“Would you like to add a second bottle and save $0.76?”), a second option to provide offer information in terms of additional money required for purchase (Would you like to add a second bottle for only $0.73?”), and a third option to provide offer information in terms of total price (“Would you like to buy two bottles for only $2.22?”). In such an embodiment, users or operators of the interactive content system may configure each message for the type of script to provide, or may configure a subset or all messages to provide the same type of script. Any other options for script customization and manipulation are contemplated as within the scope of the present disclosure.

In an embodiment, an interactive content system may be configured to automatically create messages based on statistical analysis of product sales and/or pairing frequency. Numerous factors may be taken into account in such analysis, including, but not limited to, time of day/week/month/year, store location, and store specific sales history. Note also that dynamic message generation may be based on software or pricing rules. Such rules may be imported into an interactive content system from an external system. Using such data and/or rules, an interactive content system may determine items that most frequently sell with specific items and dynamically generate a message for any item or combination of items in a transaction. Purchase frequency may be combined with additional information such as inventory levels, item price, item profitability, any discounts currently applicable to an item, etc., to create a message with a higher likelihood of being accepted by a customer or to create a message with another goal such as maximizing profit or clearing aging or excess inventory.

As noted herein, the software rules used to determine the messages to display may reside locally on an interactive content unit or system, such a system may transmit data to a server and the server may be configured to determine the messages to show. For example, item and transaction information may be encoded as an Extensible Markup Language (XML) document and transferred from an interactive content unit or system to a server in a data center via the Hypertext Transfer Protocol (HTTP) protocol over the Internet. Servers in such a data center may receive the item and transaction information, determine one or more messages that are most appropriate for display to a customer, and transmit such messages and/or related information back to the interactive content unit or system. Where an interactive content unit or system receives only information about the determined messages, the interactive content unit or system may determine that the message and/or content thereof is not available locally, and may therefore use the information to download the message and/or message content and prepare it for display to a customer.

Messages and message content may be generated and/or stored in, and/or converted to any format, including, but not limited to, JPG images, MP3 audio files, MPG movies, MACROMEDIA® Flash movies, PDF documents, web pages, static media files with dynamic textual or animation elements applied, and user interactive software programs.

The presently disclosed subject matter may be integrated into existing POS systems using any means and methods. For example, targeted interactive content functionality may be provided by software added to existing hardware systems, or may be provided by dedicated hardware resources integrated into an existing POS system. When a targeted interactive content system is not initially integrated into a POS system, the POS system may be configured to transmit item UPCs and other transaction information to the interactive content system in real or near-real time. Transmission may be done via shared memory on a single computer, a shared file system, a network, and/or a serial, USB, or other connection type. In an embodiment, statistics may be used by an interactive content system instead of, or in addition to, actual item and transaction data. For example, instead of receiving input from POS system directly that signals the end of a customer transaction or the start of a new customer transaction, an interactive content system may be configured to evaluate the time period between scans to determine whether products are grouped together as part of a single transaction or if scans belonged to different customers.

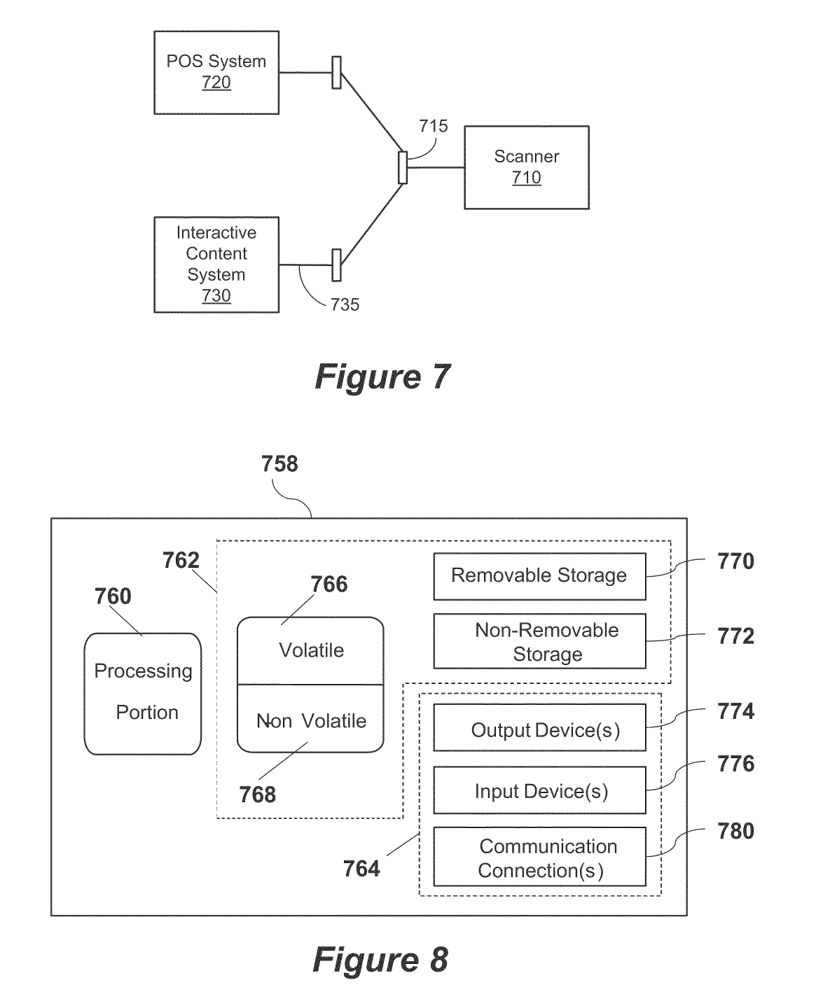

In embodiments where input signals are intercepted by an interactive content system, such input signals may be obtained by splitting or sniffing such signals sent from a scanner to POS system, as illustrated in FIG. 7. In this embodiment, the signal from scanner 710 may be split at splitter 715 and directed to both POS system 720 and interactive content system 730. POS systems may use many connector and signal types to connect to scanners including but not limited to DB9, RJ11, RJ45, PS/2, and USB connectors and serial, RS232, keyboard, OPOS, JPOS, and USB signals. In an embodiment where an RS232 signal is used, for example over a DB9, RJ11, or RJ45 cable, to connect scanner 710 and POS system 720, a Y serial splitter cable may be used to split the signal from the scanner and provide it to both POS system 720 and interactive content system 730. In such an embodiment, in order to ensure that interactive content system 730 only receives data and cannot transmit data to scanner 710 (thus ensuring that interactive content system 730 is “invisible” to scanner 710 and POS system 720), cable 735, may be configured with only the receive data to host and signal ground pins connected to the interactive content system 730.

In an embodiment, an RS232 splitter cable may be configured so that scanner 710 and interactive content system 730 may both transmit signals to the POS system 720. This type of connection may be used in embodiments where the interactive content system allows customers and/or cashiers to send additional items to the POS for purchase. In the case of an RS232 signal, this may be accomplished by additionally connecting a transmit data pin to an interactive content system. Given the specific nature of many RS232 drivers, diodes may be placed inline on the scanner's and interactive content system's transmit pins and a resister may be used to bias the POS system's receive data pin to the ground pin.

In another embodiment, the data transferred over a USB connection may be sniffed by electrically active electronics that may be configured to extract parts of the signal and send such parts of the signal to an interactive content system while not modifying the original input signal. In an embodiment, a USB protocol analyzer may be used to extract parts or all of the signal traveling over a USB communications link.

In another embodiment, a scanner connected to POS system may be disconnected from the POS system and connected to a programmable computing device that may be connected to the POS system as if it were a scanner. This embodiment may represent a “daisy chain” method instead of a “splitter method” of providing interactive content system interaction with a POS system. The programmable computing device may read signals from the scanner and transmit them to the POS system and, in an embodiment, to any other devices of the interactive content system, to other interactive content systems, and/or to any other device or system. This embodiment may be especially useful in systems where a POS system connects to a scanner via USB. USB may be more difficult to split than other protocols. A specific example here may connect a USB scanner to the programmable computing device that relays scanners signals to the POS through the original USB port or through a secondary port using a different signal type such as an auxiliary RS232 port.

In another embodiment, a TCP-IP hub (rather than a switch) may be inserted between a POS system and a scanner or other signal generating device. Once attached to such a hub with the POS system and the scanner, an interactive content system may be configured with TCP-IP sniffing software, and may capture the signal intended for the POS.

One skilled in the art will realize that there are many ways to intercept signals from peripheral devices connected to a POS. There are similarly many ways for an interactive content system to send signals back to the POS impersonating the original peripheral or perhaps by being configured as an additional peripheral device. All such mechanisms for intercepting signals from peripherals and sending new signals to the POS are contemplated as within the scope of the current disclosure.

In an alternative embodiment, a signal sent from a POS system to a POS display (e.g., a “pole” display) may split or sniffed. Many pole displays are based on simple seven segment displays (similar to the numbers on a digital clock). The signals sent to such devices may be intercepted and translated back into the alpha numeric data intended to be shown by the pole display. In this embodiment, the item, the price of an item, and information identifying the separation between transactions may be obtained.

In an alternative embodiment, a POS system may be configured to transmit data about the pending transaction through various mechanisms. One such mechanism is through a receipt printer port. Another such mechanism is through a data feed over a TCP-IP network. Another mechanism is to query the POS system about the ongoing transaction through software APIs provided by the POS system. One skilled in the art will realize that there are numerous ways to intercept and/or query information about a pending transaction on a POS system. All such mechanisms of intercepting outgoing signals or querying a POS about a pending transaction are contemplated as within the scope of the current disclosure.

In an embodiment, additional inputs may be used in addition to, or instead of, POS data such as scanner data. A separate bar code scanner, RF ID reader, or similar device may be configured on a checkout counter proximate to a POS scanner and may be used to independently acquire item identification data. Cameras may be used to capture images that an interactive content system may process in order to determine shopper transaction boundaries, identification of specific products being sold, customer facial recognition, customer queue length, the length of time a customer has been in the store, and/or any other data that may be obtained from an image. In an embodiment, a fingerprint readers may be used for customer/cashier/operator identification that may be used by an interactive content system. GPS components may be used for location awareness and to allow an interactive content system to determine a retail location. Magnetic stripe readers may be used to read data from credit cards, debit cards, and other card in order to determine customer identification. Scales may be used to determine weight and quantity and provide such data to an interactive content system Infrared cameras may be used to gather heat imagery to allow an interactive content system to determine the heat of an item. Any other type of external system, peripheral device, or any other type of device that may be configured to provide input to an interactive content system is contemplated as within the scope of the present disclosure.

In an embodiments where a retail location does not have an existing network for an interactive content system to use to communicate with other computers and devices in order to determine the messages to display and to obtain content for such messages, a wireless modem may be built into or attached to such an interactive content system. Alternatively, all rules and content may be stored directly on an interactive content system and updated by DVD, memory card, or other physical memory transfer device.

Note that any of the embodiments described above may be performed at a physical distance from the POS system, and may also be performed using a customer's equipment. For example, contemplated herein is an interactive content system that may be in communication with a customer's wireless communication device (e.g., a wireless telephone, smart phone, tablet computer, etc.) The customer may scan, using a scanner configured on or communicatively connected with the customer's wireless communication device, a bar code or UPS code of items in a store while the customer is in the store. The interactive content system may then transmit messages and/or offers as described herein to the customer's wireless communication device, thereby notifying the customer of such offers before the customer approaches the POS system. This may enable the customer to gather any items desired in response to an offer or message before approaching the cashier, potentially making check-out quicker by reducing the time spent at the POS system.

FIG. 8 is a block diagram of an example processor 758 that may be employed in any of the embodiments described herein, including as one or more components of devices 130, 132, 152, 154, 160, and 170, or as one or more components of communications network equipment or related equipment, such as any component of network 180, and/or as one or more components of any device, component, system, or subsystem that may implement any portion of the subject matter described herein. It is emphasized that the block diagram depicted in FIG. 8 is exemplary and not intended to imply a specific implementation. Thus, the processor 758 may be implemented as a single processor or multiple processors. Multiple processors may be distributed or centrally located. Multiple processors may communicate wirelessly, via hard wire, or any combination thereof.

The processor 758 may include a processing portion 760, a memory portion 762, and an input/output portion 764. The processing portion 760, memory portion 762, and input/output portion 764 may be coupled together (coupling not shown in FIG. 8) to allow communications between these portions. The input/output portion 764 may be capable of providing and/or receiving components, commands, and/or instructions, such as item identification data or transaction data, message content, message determination queries, utilized to, for example, operate an interactive content system or any subsystem or component thereof.

The processor 758 may be implemented as a client processor and/or a server processor. In a basic configuration, the processor 758 may include at least one processing portion 760 and memory portion 762. The memory portion 762 can store any information utilized in conjunction with transmitting, receiving, and/or processing item identification data, transaction data, message content, message determination queries, or any other data or information. For example, as described above, the memory portion is capable of storing item identification data, transaction data, message content, message determination queries, and/or software capable of operating an interactive content system and/or a device and software configured to interact with an interactive content system. Depending upon the exact configuration and type of processor, the memory portion 762 may be volatile (such as RAM) 766, non-volatile (such as ROM, flash memory, etc.) 768, or a combination thereof. The processor 758 may have additional features/functionality. For example, the processor 758 may include additional storage (removable storage 770 and/or non-removable storage 772) including, but not limited to, magnetic or optical disks, tape, flash, smart cards or a combination thereof. Computer storage media, such as memory and storage elements 762, 770, 772, 766, and 768, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 758. Any such computer storage media may be part of or communicatively connected to the processor 758.

The processor 758 may also contain the communications connection(s) 780 that allow the processor 758 to communicate with other devices, for example through network 180 or communications links 131, 133, 135, 153, 155, 161, or 171. Communications connection(s) 780 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein includes both storage media and communication media. The processor 758 also can have input device(s) 776 such as keyboard, keypad, mouse, pen, voice input device, touch input device, etc. Output device(s) 774 such as a display, speakers, printer, etc. also may be included.

While example embodiments of systems and methods for targeted interactive content described herein have been described in connection with various communications devices and computing devices/processors, the underlying concepts may be applied to any communications or computing device, processor, or system capable of implementing the systems and methods described. The various techniques described herein may be implemented in connection with hardware or software or, where appropriate, with a combination of both. Thus, the methods and apparatuses for providing targeted interactive content, or certain aspects or portions thereof, may take the form of program code (i. e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for or a component of a targeted interactive content system. In the case of program code execution on programmable computers, the computing device will generally include a processor, a storage medium readable by the processor (including volatile and/or non-volatile memory and/or storage elements), at least one input device, and at least one output device. The program(s) may be implemented in assembly or machine language, if desired. The language may be a compiled or interpreted language, and may be combined with hardware implementations.

The methods and systems for providing targeted interactive content as described herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a wireless telephone, or the like, the machine becomes an apparatus for a targeted interactive content system. When implemented on a general-purpose processor, the program code combines with the processor to provide a unique apparatus that operates to invoke the functionality of a targeted interactive content system. Additionally, any storage techniques used in connection with a targeted interactive content system can invariably be a combination of hardware and software.

While systems and methods have been described herein in connection with the various embodiments of the various figures, it is to be understood that other similar embodiments can be used or modifications and additions can be made to the described embodiments for performing the same functions without deviating from the described systems and methods. For example, one skilled in the art will recognize that targeted interactive content systems, devices, and configurations as described in the present application may apply to any environment, utilizing wired or wireless communications means, and may be applied to any number of such devices connected via one or more communications networks and interacting across such networks. Therefore, targeted interactive content systems such as those described herein should not be limited to any single embodiment, but rather should be construed in breadth and scope in accordance with the appended claims.

What is claimed is:

1. An interactive content system, comprising:
a first input configured to receive item identification data for an item;
a processor configured to determine a plurality of potential messages based on the item identification data;
the processor further configured to determine a ranking for each of the plurality of potential messages;
the processor further configured to determine a highest ranking message from among the plurality of potential messages;
the processor further configured to determine a plurality of message items associated with the highest ranking message;
the processor further configured to determine a ranking for each of the plurality of message items;
the processor further configured to determine a display format of the highest ranking message based on the ranking for each of the plurality of message items; and
a first transmitter configured to transmit the highest ranking message to a display.

2. The interactive content system of claim 1, wherein the processor is further configured to determine a script for the highest ranking message, wherein the script comprises cues for a cashier to provide verbal item information to a customer, and wherein the first transmitter is further configured to transmit the script to the display.

3. The interactive content system of claim 2, wherein the processor determines the script for the highest ranking message by determining a selection of one of a plurality of scripts associated with the highest ranking message.

4. The interactive content system of claim 1, further comprising a second input configured to receive an indication of a selection of a first message item from the display; and
the processor further configured to transmit item identification data for the first message item to a point of sale system.

5. The interactive content system of claim 1, wherein the highest ranking message comprises a code associated with a first message item, the code capable of being detected by a point of sale system scanner.

6. The interactive content system of claim 1, wherein the processor is configured to determine the ranking for each of the plurality of potential messages based on compensation received from a distributor of a message item associated with that message.

7. The interactive content system of claim 1, wherein the processor is configured to determine the ranking for each of the plurality of potential messages based on a relative inventory level of a message item associated with that message.

8. The interactive content system of claim 1, wherein the processor is configured to determine the ranking for each of the plurality of potential messages based on a profit margin of a message item associated with that message.

9. The interactive content system of claim 1, wherein the processor is configured to determine the ranking for each of the plurality of potential messages based on a likelihood of customer purchase of a message item associated with that message when the message item is offered for purchase with the item.

10. A method of providing interactive content, comprising:
receiving item identification data at an interactive content system;
determining a plurality of messages based on the item identification data at the interactive content system;
determining a ranking for each of the plurality of messages at the interactive content system;
determining a highest ranking message from among the plurality of messages at the interactive content system;
determining a plurality of message items associated with the highest ranking message at the interactive content system;
determining a ranking for each of the plurality of message items at the interactive content system;
determining a display format of the highest ranking message based on the ranking for each of the plurality of message items;
displaying the highest ranking message in the display format on a first display of the interactive content system;
detecting a selection of a first message item at the interactive content system; and
transmitting first message item identification data from the interactive content system.

11. The method of claim 10, further comprising determining current transaction data at the interactive content system, wherein the highest ranking message comprises the current transaction data.

12. The method of claim 10, wherein the highest ranking message comprises a first message and a second message, wherein displaying the highest ranking message in the display format on the first display comprises displaying the first message on the first display, the method further comprising displaying the second message on a second display of the interactive content system.

13. The method of claim 12, wherein the second message comprises a script based on the highest ranking message, wherein the script comprises cues for a cashier to provide verbal item information to a customer.

14. The method of claim 13, further comprising determining the script by determining a selection of one of a plurality of scripts associated with the highest ranking message.

15. The method of claim 10, wherein detecting the selection of the first message item at the interactive content system comprises receiving an indication of the selection of the first message item from the first display.

16. The method of claim 10, wherein displaying the highest ranking message in the display format on the first display of the interactive content system comprises:
determining a number of messages that have been displayed;
determining that the number of messages is less than a threshold; and
responsive to determining that the number of messages is less than the threshold, displaying the highest ranking message in the display format on the first display of the interactive content system

17. An interactive content unit, comprising:
a processor configured to generate an interactive content message by:
determining a plurality of messages,
determining a ranking for each of the plurality of messages,
selecting a first message based on the ranking for each of the plurality of messages,
determining a message item associated with the first message, and
determining a format of the first message;
a display configured to present the first message and detect a selection of the message item.

18. The interactive content unit of claim 17, wherein determining the plurality of messages comprises:
determining that there are no messages associated with a detected item, and determining the plurality of messages based on transaction data.

19. The interactive content unit of claim 18, wherein determining the plurality of messages comprises generating at least one of the plurality of messages based on rules imported from a system external to the interactive content unit.

20. The interactive content unit of claim 17, wherein the processor is further configured to generate the interactive content message by determining a script associated with the first message, wherein the script comprises cues for a cashier to provide verbal item information to a customer.
